(19) United States
(12) Patent Application Publication
(10) Pub. No.: US 2025/0300219 A1
(43) Pub. Date: Sep. 25, 2025

(54) METHOD FOR MANUFACTURING A SOLID SULFIDE ELECTROLYTE

(71) Applicant: Umicore, Brussels (BE)

(72) Inventors: Fabienne GSCHWIND, Olen (BE); Ruben DICKENS, Olen (BE)

(21) Appl. No.: 18/863,777

(22) PCT Filed: May 8, 2023
(86) PCT No.: PCT/EP2023/062093

§ 371 Date: Nov. 7, 2024

(30) Foreign Application Priority Data
May 9, 2022 (EP) 22172391.9

(51) Int. Cl. H01M 10/0562; H01M 6/18; H01M 10/0525

(52) U.S. Cl. CPC H01M 10/0562; H01M 6/182; H01M 10/0525; H01M 2300/008

(57) ABSTRACT

The present invention relates to a method for manufacturing a solid sulfide electrolyte by mixing of the solid electrolyte precursor comprising Li₂S, Li₃PS₄ and LiX, such as LiCl. The present inventors have demonstrated that a low-energy mixing step is sufficient to prepare the solid electrolyte mixture, which after subjection to the heat-treatment affords the solid sulfide electrolyte having an argyrodite-type crystal structure in high purity.

### TECHNICAL FIELD AND BACKGROUND

This invention relates to a method for manufacturing a solid sulfide electrolyte and the solid sulfide electrolyte obtainable from said method.

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Among these, a lithium secondary battery has come into the spotlight as a high-performance battery due to a high energy density and a high reference electrode potential.

However, electrolytes conventionally used in lithium secondary batteries are liquid electrolytes such as organic solvents. Accordingly, safety problems such as leakage of electrolytes and risk of fire may continuously occur.

Recently, solid state batteries including solid electrolytes, rather than liquid electrolytes have been used to improve the safety feature of the lithium secondary battery and have attracted much attention. For example, solid electrolytes are typically safer than liquid electrolytes due to non-combustible or flame retardant properties.

Solid electrolytes may include oxide-based solid electrolytes, polymer-based electrolytes and sulfide based electrolytes. Sulfide-based electrolytes have been generally used due to their higher lithium ionic conductivity range compared to oxide-based and polymer-based solid electrolytes, such as sulfide-based solid electrolytes having an argyrodite-type crystal structure.

Conventionally, a method for manufacturing a sulfur-based solid electrolyte with a mixture obtained by milling and vitrifying the powders Li₂S, P₂S₅ and a lithium halide, such as LiCl or LiBr, has been used. In this conventional method of manufacturing the solid electrolyte, a high-energy milling process followed by a heat-treatment step (i.e. calcination step) is required for converting the mixture of powders to the sulfide-based electrolyte having an argyrodite structure. However, this high-energy milling step has the drawback of requiring high amounts of energy, which make scaling up the process towards mass-production of the sulfide-based electrolyte limited. Examples of this high-energy milling step are ball-milling or mechanical milling of the starting materials. US2019/0198917 A1, US2020/0028207 A1 and US 2020/0385131 A1 describe this high-energy milling method for manufacturing sulfide-based electrolytes. High-energy ball milling use a milling speed of 200 rpm up to 1200 rpm and even higher milling speeds.

Hence, there is a need to provide a method for manufacturing a solid sulfide electrolyte which requires less energy input and can be upscaled for mass-production of the solid sulfide electrolyte.

It is an object of the present invention to provide a method for manufacturing a solid sulfide electrolyte.

It is a further object of the present invention to provide the solid sulfide electrolyte obtainable from said method.

It is a further object of the present invention to provide a solid-state lithium battery comprising said solid sulfide electrolyte.

### SUMMARY OF THE INVENTION

In a first aspect an object of the present invention is achieved by providing a method for manufacturing a solid sulfide electrolyte by providing a solid electrolyte precursor mixture comprising Li₂S, Li₃PS₄ and LiX.

The present inventors surprisingly have found that by mixing of the solid electrolyte precursor mixture comprising Li₂S, Li₃PS₄ and LiX, such as LiCl, there is no need of a high-energy milling step to prepare the solid sulfide electrolyte. As demonstrated in the appended examples a low-energy mixing step is sufficient to prepare the solid electrolyte mixture, which after subjection to the heat-treatment affords the solid electrolyte having an argyrodite-type crystal structure in high purity. In contrast, the present inventors have demonstrated that by providing a mixture comprising Li₂S, P₂S₅ and LiCl subjected to the same low-energy mixing step, followed by heat-treating does not afford the solid sulfide electrolyte having an argyrodite-type crystal structure in sufficient purity: the solid mixture still contains high amounts of unreacted starting material which is detrimental for the ionic and/or electronic conductivity of the overall mixture.

In situ formation of Li₃PS₄ starting from Li₂S and P₂S₅ has been reported (Jiang, H. et al, Ionics 2020, 26, 2335-2342). However, the present inventors clearly demonstrate that starting from Li₃PS₄ instead of a mixture of Li₂S and P₂S₅ a solid sulfide electrolyte having an argyrodite-type crystal structure in higher purity and concomitantly a higher ionic conductivity is obtained using a low-energy process.

Without wishing to be bound by any theory, the present inventors believe that by using P₂S₅ as a starting material more energy is needed towards the formation of Li₆PS₅Cl as by using Li₃PS₄ as starting material. P₂S₅ has an adamantane-like crystal structure, for which it is assumed that more energy is needed to open or break the crystal structure for forming Li₆PS₅Cl, which has a cubic crystal structure. In contrast, it is believed that by using Li₃PS₄, which has a orthorhombic crystal structure, less energy is needed to deform the crystal structure towards Li₆PS₅Cl.

In a further aspect the invention provides the solid sulfide electrolyte obtainable by the method according to the invention.

In a further aspect the invention provides the solid-state battery comprising the solid sulfide electrolyte obtainable by the method according to the invention.

### BRIEF DESCRIPTION OF THE FIGURES

FIG. 1: XRD spectrum of the dome sample holder.

FIG. 2: XRD spectrum of heat-treated solid sulfide electrolyte of Example 1.

FIG. 3: XRD spectrum of heat-treated solid sulfide electrolyte of Example 2.

FIG. 4: XRD spectrum of heat-treated solid sulfide electrolyte of Example 3.

FIG. 5: First charge-discharge curve of Example 4.

FIG. 6: Rate capability test of Example 4.

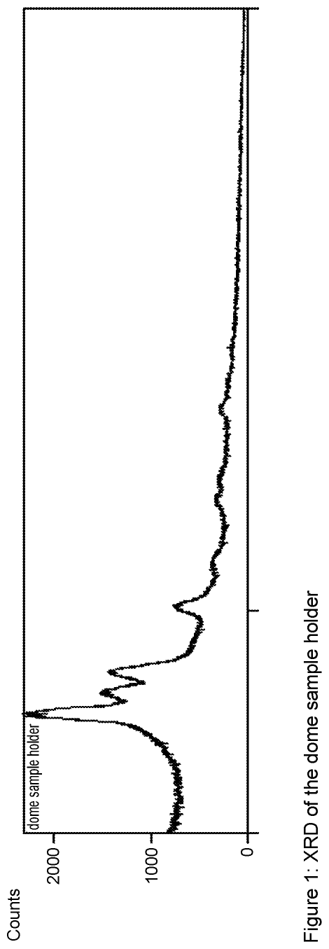

### DETAILED DESCRIPTION

In the drawings and the following detailed description, preferred embodiments are described in detail to enable practice of the invention. Although the invention is described with reference to these specific preferred embodiments, it will be understood that the invention is not limited to these preferred embodiments. In contrast, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

The term “solid-state battery” as used herein refers to a cell or battery that includes only solid or substantially solid-state components such as solid electrodes (e.g. anode and cathode) and solid electrolyte.

The term “argyrodite-type crystal structure” as used herein refers to a crystal structure having a crystal structure or system similar to naturally existing Ag₈GeS₆ and Li₇S₆(Argyrodite). The argyrodite-type crystal may be orthorhombic having Pna21 space group and having a unit cell of a=15.149, b=7 476, c=10 589 [Å]; Z=4. In some embodiments the argyrodite-type crystal structure may also be empirically determined for example, by X-ray diffraction spectroscopy by observing peaks around at 2θ=15.5±1°, 18±1°, 26±1°, 30.5±1° and 32±1° using CuKα-ray.

The ionic conductivity as referred to herein, refers to the ionic conductivity determined by electrochemical impedance spectroscopy (EIS) at 25° C. It is preferably determined with ion-blocking electrodes on cold pressed samples which were densified at 350 MPa at 125° C. for 5 min after which the ionic conductivity was measured at 25° C. under an operational pressure of 125 MPa. Preferably an excitation voltage of 10 mV was applied in the frequency range of 7 MHz-1 Hz and the data was interpreted by means of an equivalent circuit analysis. A suitable conductivity analyzer is a potentiostat with frequency analyzer such as is available from Biologic.

The electronic conductivity as referred to herein, refers to the electronic conductivity determined at 25° C. It is preferably determined with ion-blocking electrodes on hot pressed samples which were densified at 350 MPa at 125° C. for 5 min after which the electronic conductivity was measured at 25° C. under an operational pressure of 125 MPa. Preferably the electronic conductivity was measured via stepwise potentiostatic polarization at 0.2, 0.4 and 0.6 V for 20 min. A suitable conductivity analyzer is a potentiostat with frequency analyzer such as is available from Biologic.

X-ray diffraction (XRD) spectroscopy as referred to herein, refers to XRD experiments performed using Panalytical X'Pert Pro with a Cu Kalpha1 source (1.5405980 A or 8.05 keV). Preferably, the sample holder is an Anton Paar holder with PEEK dome and the software used for analysis was Highscore.

### Method for Manufacturing

As discussed above in a first aspect the invention provides a method for manufacturing a solid sulfide electrolyte comprising the following steps:
providing a solid electrolyte precursor mixture comprising Li₂S, Li₃PS₄ and LiX;
mixing of the solid electrolyte precursor mixture to obtain a solid electrolyte mixture; and
heat-treating of the solid electrolyte mixture to obtain a solid sulfide electrolyte having an argyrodite-type crystal structure;
   wherein X is an halogen selected from F, Cl, Br, I or combinations thereof.

The term “solid electrolyte precursor mixture” or solid electrolyte mixture” as used herein refers to a electrolyte precursor mixture or electrolyte mixture being essentially free of any liquid. The term “essentially free of liquid” means that the solid electrolyte precursor mixture and/or the solid electrolyte mixture comprises less than 10 wt. % of a liquid by total weight of the solid electrolyte precursor mixture and/or the solid electrolyte mixture, preferably less than 7.5 wt. %, more preferably less than 5 wt. %, even more preferably less than 2.5 wt. %, most preferably less than 1 wt. % by total weight of the solid electrolyte precursor mixture and/or the solid electrolyte mixture. In a more preferred embodiment the solid electrolyte precursor mixture and/or the solid electrolyte mixture comprises less than 1000 ppm of a liquid by total weight of the solid electrolyte precursor mixture and/or the solid electrolyte mixture, preferably less than 500 ppm, more preferably less than 100 ppm, even more preferably less than 50 ppm, most preferably less than 10 ppm by total weight of the solid electrolyte precursor mixture and/or the solid electrolyte mixture. In the context of the present invention a liquid shall be considered to be an organic or aqueous compound which is liquid in standard conditions for temperature and pressure as defined by the IUPAC. Hereby the boiling point and the melting point shall be considered to be the boiling point and the melting point at standard atmospheric pressure, i.e. at 101325 Pa. As appreciated by the skilled person the presence of the organic liquid can be determined via thermogravimetric analysis (TGA) or nuclear magnetic resonance (NMR) spectroscopy and the presence of the aqueous liquid can be determined via Karl Fisher titration.

As appreciated by the skilled person every crystal structure of Li₃PS₄ can be used in the method of the invention, in particular γ-, α- and β-polymorph of Li₃PS₄.

A preferred embodiment of the invention is the method according to the invention, wherein the solid sulfide electrolyte is represented by formula (I)

Li_{7-y}PS_{6-y}X_{y} (I)

wherein y=0.8-1.7. As appreciated by the skilled person when y is 0.8 to 1.7, it is possible to obtain the a solid sulfide electrolyte having an argyrodite-type crystal structure. In a more preferred embodiment y is 0.8 to 1.7, y is preferably 0.9 or more and 1.6 or less, and more preferably y is 1.0 or more and 1.4 or less.

A highly preferred embodiment is the method according to the invention, wherein the solid sulfide electrolyte is represented by formula (II)

Li₆PS₅X (II).

A preferred embodiment is the method according to the invention, wherein X=Cl, Br, I or combinations thereof; preferably X=Cl, Br or combinations thereof; more preferably X=Cl.

In accordance with preferred embodiments of the invention, the solid sulfide electrolyte is provided wherein at least 50 mol % of X represents Cl, preferably at least 80 mol % of X represents Cl, most preferably X represents Cl.

In accordance with preferred embodiments of the invention, the solid sulfide electrolyte is provided wherein X represents Cl, Br, I or a combination thereof and wherein at least 50 mol % of X represents Cl, preferably at least 80 mol % of X represents Cl.

In accordance with preferred embodiments of the invention, the solid sulfide electrolyte is provided wherein at least 50 mol % of X represents Br, preferably at least 80 mol % of X represents Br, most preferably X represents Br.

In accordance with preferred embodiments of the invention, the solid sulfide electrolyte is provided wherein X represents Cl, Br, I or a combination thereof and wherein at least 50 mol % of X represents Br, preferably at least 80 mol % of X represents Br.

In accordance with preferred embodiments of the invention, the solid sulfide electrolyte is provided wherein at least 50 mol % of X represents I, preferably at least 80 mol % of X represents I, most preferably X represents I.

In accordance with preferred embodiments of the invention, the solid sulfide electrolyte is provided wherein X represents Cl, Br, I or a combination thereof and wherein at least 50 mol % of X represents I, preferably at least 80 mol % of X represents I.

A highly preferred embodiment is the method according to the invention, wherein X=Cl, Br or I; preferably X=Cl or Br; more preferably X=Cl.

A preferred embodiment is the method according to the invention, wherein the molar ratios of Li₂S:Li₃PS₄:LiX are between (0.5-1.5):(0.5-1.5):(0.5-1.5), preferably between (0.75-1.25):(0.75-1.25):(0.75-1.25), more preferably between (0.9-1.1):(0.9-1.1):(0.9-1.1). In a more preferred embodiment the molar ratios of Li₂S:Li₃PS₄:LiX are between (0.95-1.05):(0.95-1.05):(0.95-1.05), preferably between (0.98-1.02):(0.98-1.02):(0.98-1.02), more preferably between (0.99-1.01):(0.99-1.01):(0.99-1.01). In a highly preferred embodiment the molar ratios of Li₂S:Li₃PS₄:LiX are about 1:1:1.

A preferred embodiment is the method according to the invention, wherein the molar ratios of Li:P:S:X are between (5-7):(0.5-1.5):(4-6):(0.5-1.5), preferably between (5.5-6.5):(0.75-1.25):(4.5-5.5):(0.75-1.25), more preferably between (5.75-6.25):(0.9-1.1):(4.75-5.25):(0.9-1.1). In a more preferred embodiment of the invention, the molar ratios of Li:P:S:X are between (5.9-6.1):(0.95-1.05):(4.9-5.1):(0.95-1.05), preferably between (5.95-6.05):(0.98-1.02):(4.95-5.05):(0.98-1.02), more preferably between (5.98-6.02):(0.99-1.01):(4.98-5.02):(0.99-1.01). In a highly preferred embodiment the molar ratios of Li:P:S:X are about 6:1:5:1.

A preferred embodiment is the method according to the invention by mixing the solid electrolyte precursor mixture with a mixing speed between 1 and 1000 rpm, preferably between 1 and 750 rpm, more preferably between 1 and 500 rpm. In accordance with highly preferred embodiment mixing of the solid electrolyte precursor mixture with a mixing speed between 1 and 250 rpm, preferably between 10 and 150 rpm, more preferably between 50 and 100 rpm.

A preferred embodiment is the method according to the invention, wherein the mixing occurs at a mixing time of at least 1 min, preferably at least 0.5 hour, more preferably at least 1 hour, even more preferably at least 2 hours, even more preferably at least 5 hours, most preferably at least 10 hours. A preferred embodiment is the method according to the invention, wherein the mixing occurs at a mixing time of less than 72 hours, preferably less than 60 hours, more preferably less than 50 hours, even more preferably less than 36 hours, even more preferably less than 30 hours, most preferably less than 24 hours. A preferred embodiment is the method according to the invention by mixing of the solid electrolyte precursor mixture at a mixing time between 1 hour and 72 hours, preferably between 2 hours and 60 hours, more preferably between 10 hours and 50 hours.

In accordance with highly preferred embodiments of the invention mixing of the solid electrolyte precursor mixture occurs:
a mixing speed between 1 and 250 rpm, preferably between 10 and 150 rpm, more preferably between 50 and 100 rpm; and
a mixing time between 1 hour and 72 hours, preferably between 2 hours and 60 hours, more preferably between 10 hours and 50 hours.

As appreciated by the skilled person in certain embodiments mixing of the solid electrolyte precursor mixture is the same as milling, mechanical milling, pulverization, grinding or dry-grinding of the solid electrolyte precursor mixture. In accordance with preferred embodiments of the method mixing of the solid electrolyte precursor mixture of the invention requires less energy to obtain the solid sulfide electrolyte after heat-treating.

A preferred embodiment is the method according to the invention, wherein the mixing of the solid electrolyte precursor mixture is carried out by using a mixing means, preferably the mixing means is a low-energy mixing means such as ball mill such as an electric ball mill, a vibration ball mill, a planetary ball mill, a vibration mixer mill or a SPEX mill; a bead mill; a homogenizer; a screw mixer; a horizontal mixer; a ploughshare mixer; a jar mill; a drum mill or a roller bench, more preferably the mixing means is a screw mixer, a horizontal mixer or roller bench, most preferably a roller bench. In certain embodiments the mixing means is a non-planetary ball mill. As appreciated by the skilled person a non-planetary ball mill is any ball mill not being a planetary ball mill. Moreover a non-planetary ball mill will be any ball mill imposing a low energy mixing on the solid electrolyte precursor mixture. In a more preferred embodiment mixing of the solid electrolyte precursor mixture is carried out by adding one or more ceramic or zirconia balls to the solid electrolyte precursor mixture to obtain the solid electrolyte mixture. As appreciated by the skilled person the amount and size of the ceramic or zircona balls is changed in view of the total solid amount of the solid electrolyte precursor mixture. As appreciated by the skilled person these ceramic or zirconia balls are removed from the solid electrolyte mixture before heat-treating the solid electrolyte mixture. In accordance with certain embodiments the mixing means applies an inertial force of less than 38 G on the solid electrolyte precursor mixture, preferably less than 25 G, more preferably less than 10 G. In accordance with preferred embodiments the mixing means applies an inertial force of more than 1 G on the solid electrolyte precursor mixture, preferably more than 1.5 G, more preferably more than 2 G. In accordance with preferred embodiments the mixing means applies an inertial force between 1 G and 38 G on the solid electrolyte precursor mixture, preferably between 1.5 G and 25 G, more preferably between 2 G and 10 G.

A preferred embodiment is the method according the invention, wherein the mixing occurs a temperature of at least 5° C., preferably at least 10° C., more preferably at least 15° C. A preferred embodiment is the method according to the invention, wherein the mixing occurs at a temperature of less than 50° C., preferably less than 40° C., more preferably less than 30° C. A preferred embodiment is the method according to the invention, wherein the mixing occurs at a temperature between 5 and 50° C., preferably a temperature between 1° and 40° C., more preferably a temperature between 15 and 30° C.

A preferred embodiment is the method according to the invention, wherein the heat-treating occurs at a temperature of at least 100° C., preferably at least 200° C., more preferably at least 300° C., more preferably at least 400° C., even more preferably at least 450° C., most preferably at least 500° C. A preferred embodiment is the method according to the invention, wherein the heat-treating occurs at a temperature of less than 1000° C., preferably less than 900° C., more preferably less than 800° C., even more preferably less than 700° C., even more preferably less than 600° C., most preferably less than 550° C. A preferred embodiment is the method according to the invention, wherein the heat-treating occurs at a temperature between 10° and 1000° C., preferably between 30° and 700° C., more preferably between 35° and 650° C.

As appreciated by the skilled person the heat-treating of the solid electrolyte mixture to obtain a solid sulfide electrolyte having an argyrodite-type crystal structure is also known as calcination of the solid electrolyte mixture towards to the formation of the argyrodite.

A preferred embodiment is the method according to the invention, wherein the heat-treating occurs under an inert atmosphere, preferably an argon atmosphere, or under an atmosphere comprising a hydrogen sulfide gas, preferably an atmosphere consisting of hydrogen sulfide gas.

A preferred embodiment is the method according to the invention, wherein the heat-treating of the solid electrolyte mixture is at least 1 min, preferably at least 0.5 hour, more preferably at least 1 hour, even more preferably at least 1.5 hours, even more preferably at least 2 hours. A preferred embodiment is the method according to the invention, wherein the heat-treating of the solid electrolyte mixture is less than 48 hours, preferably less than 24 hours, more preferably less than 18 hours, even more preferably less than 12 hours, even more preferably less than 10 hours. A preferred embodiment is the method according to the invention, wherein the heat-treating of the solid electrolyte mixture is between 0.5 hour and 24 hours, preferably between 1 hours and 12 hours, more preferably between 1.5 hours and 10 hours.

As understood in the context of the present invention no additional liquid is added to the solid electrolyte precursor mixture, meaning that the solid electrolyte precursor mixture is not solubilized and/or dispersed in a liquid to promote the formation of the solid sulfide electrolyte. Hence, the present invention provides in a highly preferred embodiment a method for manufacturing a solid sulfide electrolyte in a dried state or solid state. Worded differently, the present invention provides a mechanical milling treatment for manufacturing a solid sulfide electrolyte.

In a certain embodiment of the invention provides a method for manufacturing a solid sulfide electrolyte comprising the following steps:
providing a set of precursors comprising Li₂S, Li₃PS₄ and LIX;
mixing of the set of precursors to obtain a solid electrolyte mixture; and
heat-treating of the solid electrolyte mixture to obtain a solid sulfide electrolyte having an argyrodite-type crystal structure;
wherein X is an halogen selected from F, Cl, Br, I or combinations thereof.

As appreciated by the skilled person all previous embodiments apply mutatis mutandis to the aforementioned certain embodiment of the invention. Moreover, the term “set of precursors” as used herein refers to a composition being essentially free of any liquid. The term “essentially free of liquid” means that the set of precursors comprises less than 10 wt. % of a liquid by total weight of the set of precursors, preferably less than 7.5 wt. %, more preferably less than 5 wt. %, even more preferably less than 2.5 wt. %, most preferably less than 1 wt. % by total weight of the set of precursors. In a more preferred embodiment set of precursors comprises less than 1000 ppm of a liquid by total weight of set of precursors, preferably less than 500 ppm, more preferably less than 100 ppm, even more preferably less than 50 ppm, most preferably less than 10 ppm by total weight of the set of precursors. In the context of the present invention the terms “solid electrolyte precursor mixture” and “set of precursors” are interchangeable terms and refer to the same solid composition comprising the precursors Li₂S, Li₃PS₄ and LiX.

### The Solid Sulfide Electrolyte

A second aspect of the invention is providing a solid sulfide electrolyte obtainable by the method according to the invention.

As appreciated by the skilled person all embodiments related to the method for manufacturing the solid sulfide electrolyte according to the invention equally apply to the solid sulfide electrolyte obtainable by the method according to the invention.

A preferred embodiment is the solid sulfide electrolyte according to the invention, which does not substantially contain a phase formed from Li₂S, LiCl, Li₂PS₃ and/or Li₃PS₄ as determined by XRD, wherein the peak intensities of Li₂S, LiCl, Li₂PS₃ and/or Li₃PS₄ are less than 10% of the peak intensities of Li₆PS₅Cl, preferably less than 8%, more preferably less than 5%, most preferably less than 1%. In accordance with preferred embodiment the solid sulfide electrolyte according to the invention has a purity of at least 90% as determined by XRD, preferably a purity of at least 92%, more preferably a purity of at least 95%, most preferably a purity of at least 99%.

A preferred embodiment is the solid sulfide electrolyte according to the invention having an ionic conductivity of at least 0.25 mS/cm, preferably at least 0.5 mS/cm, more preferably at least 0.75 mS/cm, even more preferably at least 1 mS/cm, most preferably at least 1.5 mS/cm. A preferred embodiment is the solid sulfide electrolyte according to the invention having an ionic conductivity of less than 10 mS/cm, preferably less than 5 mS/cm, more preferably less than 2.5 mS/cm, even more preferably less than 2 mS/cm, most preferably less than 1.75 mS/cm. A preferred embodiment is the solid sulfide electrolyte according to the invention having a ionic conductivity between 0.25 and 10 mS/cm, preferably between 0.5 and 5 mS/cm, more preferably between 0.75 and 2.5 mS/cm.

A preferred embodiment is the solid sulfide electrolyte according to the invention having an electronic conductivity of at least 1×10⁻⁸ mS/cm, preferably at least 1×10⁻⁷ mS/cm, more preferably at least 1×10⁻⁶ mS/cm. A preferred embodiment is the solid sulfide electrolyte according to the invention having an electronic conductivity of less than 1×10⁻² mS/cm, preferably less than 1×10⁻³ mS/cm, more preferably less than 1×10⁻⁴ mS/cm. A preferred embodiment is the solid sulfide electrolyte according to the invention having an electronic conductivity between 1×10⁻⁸ and 1×10⁻² mS/cm, preferably between 1×10⁻⁷ and 1×10⁻³ mS/cm, more preferably between 1×10⁻⁶ and 1×10⁻⁴ mS/cm.

A preferred embodiment is the solid sulfide electrolyte according to the invention having XRD patterns at around 2θ=15.5±1°, 18±1°, 26±1°, 30.5±1° and 32±1° using CuKα-ray.

### Battery

A third aspect of the invention concerns a battery comprising a negative electrode, a positive electrode and a solid electrolyte layer, wherein at least one of the cathode, the anode and the solid electrolyte layer comprises the solid sulfide electrolyte according to the invention.

As appreciated by the skilled person a negative electrode is an anode and a positive electrode is a cathode. Hence, the present invention concerns a battery comprising a negative electrode, a positive electrode and a solid electrolyte layer, wherein at least one of the positive electrode, the negative electrode and the solid electrolyte layer comprises the solid sulfide electrolyte according to the invention.

The present solid sulfide electrolyte of the invention can be used as a solid electrolyte layer of a solid lithium ion battery or a solid lithium primary cell, or as a solid electrolyte that is mixed with an electrode mixture for positive electrode or negative electrode.

In a preferred embodiment the battery is a solid-state battery, preferably a lithium solid-state battery.

### Use

A fourth aspect of the invention concerns a use of the solid sulfide electrolyte according to the invention in a battery, preferably a solid-state-battery, more preferably a lithium solid-state-battery

A fifth aspect of the present invention concerns a use of the battery according to invention in either one of a portable computer, a tablet, a mobile phone, an energy storage system, an electric vehicle or in a hybrid electric vehicle, preferably in an electric vehicle or in a hybrid electric vehicle.

The invention is further illustrated in the following examples:

### EXAMPLES

### Description of Testing Methods

### XRD Analysis

XRD experiments were performed using Panalytical X'Pert Pro with a Cu Kalpha1 source was used (1.5405980 A or 8.05 keV). The sample holder was an Anton Paar holder with PEEK dome. The software used for analysis was Highscore.

### Ionic Conductivity

Ionic conductivity was measured using electrochemical impedance spectroscopy (EIS) at room temperature (25° C.) on cold pressed samples in a pellet cell with ion blocking electrodes. The samples are densified at 350 MPa. The ionic conductivity is measured under an operational pressure of 125 MPa. For the EIS an excitation voltage of 10 mV is applied in the frequency range of 7 MHz-1 Hz. The measurements are conducted with a potentiostat with frequency analyzer. The data is interpreted by the means of an equivalent circuit analysis.

### Electronic Conductivity

The electronic conductivity is measured on the same sample as the ionic conductivity (125 MPa, RT) via step-wise potentiostatic polarization at 0.2, 0.4 and 0.6 V for 20 min. The measurement is conducted with a potentiostat with frequency analyzer.

### Example 1

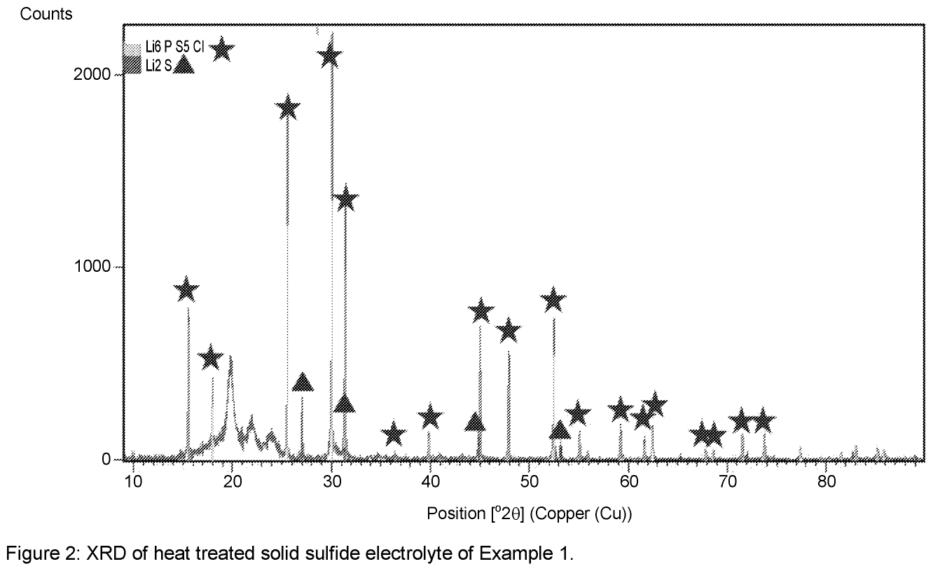

A mixture containing lithium sulfide (Li₂S, 6.8 g), lithium chloride (LiCl, 6.9 g) and lithium thiophosphate (Li₃PS₄, 27 g) was prepared. The mixture was charged in a plastic container together with Steatite balls having a diameter of 6 mm. The weight amount of balls is 400 g. The plastic bottle or container is placed on a roller bench for 24 hours at a temperature of 25° C. The roller bench generates the energy necessary for mixing of the mixture of lithium sulfide, lithium chloride and lithium thiophosphate. The specifics of the roller bench are provided in Table 1. The mixture was then transferred to a muffle furnace for a heat treatment at 525° C. by using a heating ramp of 1° C./min until 525° C. and holding at 525° C. for 8 h followed by cooling until room temperature thereby affording the solid sulfide electrolyte. The solid sulfide electrolyte was subjected to XRD analysis (see FIG. 2) demonstrating that the solid sulfide electrolyte consist of 93% Li₆PS₅Cl and 7% Li₂S. The ionic conductivity and the electronic conductivity of the solid sulfide electrolyte is 1.5 mS/cm and 2.05×10⁻⁴ mS/cm, respectively.

TABLE 1
Specifics of the roller bench (IKA Roller ®)

| Rotational speed | 80 | rpm |
|---|---|---|
| Shaking diameter (height) | 24,5 | mm |
| Number of rolls | 6 | |
| Rolls diameter | 32 | mm |
| Roll length | 327 | mm |
| Rolls, luffing angle fixed | 3° | |
| Rolls, total weight | 4, 6 | kg |
| Voltage | 100-240 | V |
| Frequency | 50-60 | Hz |
| Power input | 24 | W |
| DC voltage | 24 | V |
| Current consumption | 1000 | mA |
| Engine power consumption | 16 | W |
| Engine power output | 9 | W |

### Example 2

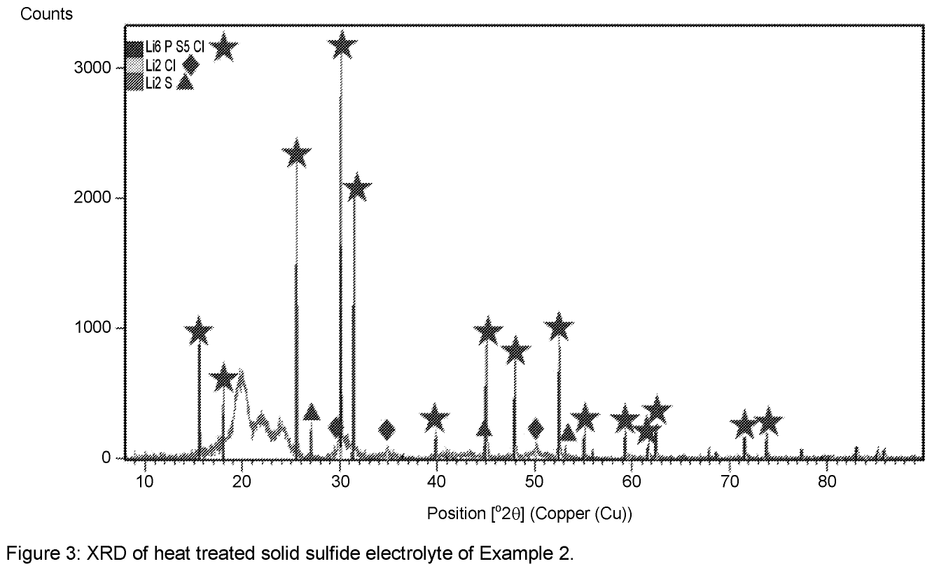

A mixture containing lithium sulfide (Li₂S, 25.7 g), lithium chloride (LiCl, 26.1 g) and lithium thiophosphate (Li₃PS₄, 100.7 g) was prepared. The mixture was charged in a plastic container together with Steatite balls having a diameter of 10 mm. The weight amount of balls is 2 kg. The plastic bottle or container is placed on a roller bench for 48 hours at a temperature of 25° C. The roller bench generates the energy necessary for mixing of the mixture of lithium sulfide, lithium chloride and lithium thiophosphate. The specifics of the roller bench are provided in Table 1. The mixture was then transferred to a muffle furnace for a heat treatment at 530° C. by using a heating ramp of 1° C./min until 530° C. and holding at 530° C. for 2 h followed by cooling until room temperature thereby affording the solid sulfide electrolyte. The solid sulfide electrolyte was subjected to XRD analysis (see FIG. 3) demonstrating that the solid sulfide electrolyte consist of 92% Li₆PS₅Cl, 5% Li₂S and 3% LiCl.

### Example 3

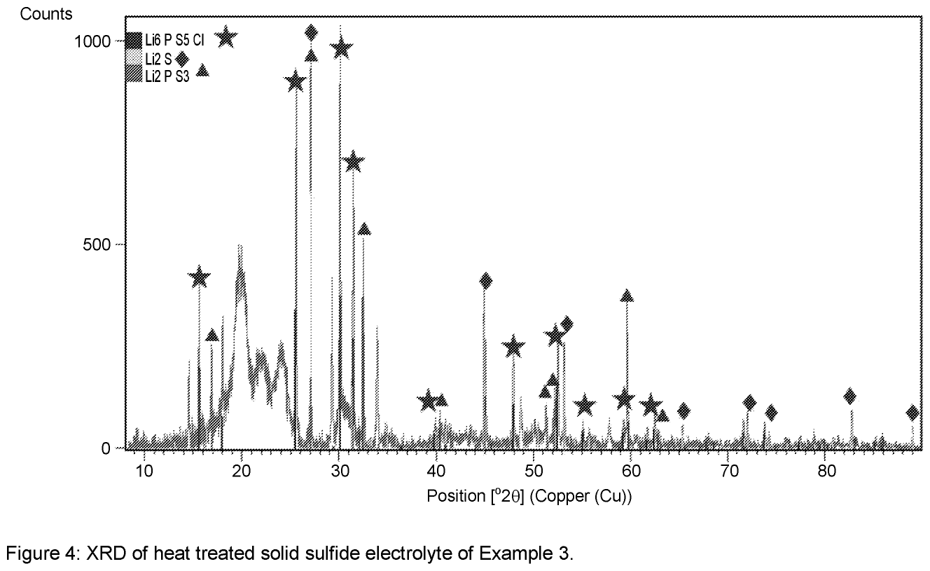

A mixture containing lithium sulfide (Li₂S, 2.1 g), lithium chloride (LiCl, 0.8 g) and phosphorus pentasulfide (P₂S₅, 2.1 g) was prepared. The mixture was charged in a plastic container together with Steatite balls having a diameter of 6 mm. The weight amount of balls is 47.7 g. The plastic bottle or container is placed on a roller bench for 48 hours at a temperature of 25° C. The roller bench generates the energy necessary for mixing of the mixture of lithium sulfide, lithium chloride and lithium thiophosphate. The specifics of the roller bench are provided in Table 1. The mixture was then transferred to a muffle furnace for a heat treatment at 500° C. by using a heating ramp of 1° C./min until 500° C. and holding at 500° C. for 6 h followed by cooling until room temperature thereby affording the solid sulfide electrolyte. The solid sulfide electrolyte was subjected to XRD analysis (see FIG. 4) demonstrating that the solid sulfide electrolyte consist of 58% Li₆PS₅Cl, 20% Li₂S and 22% Li₂PS₃. The ionic conductivity and the electronic conductivity of the solid sulfide electrolyte is 0.1 mS/cm and 4.4×10⁻⁵ mS/cm, respectively.

### Example 4

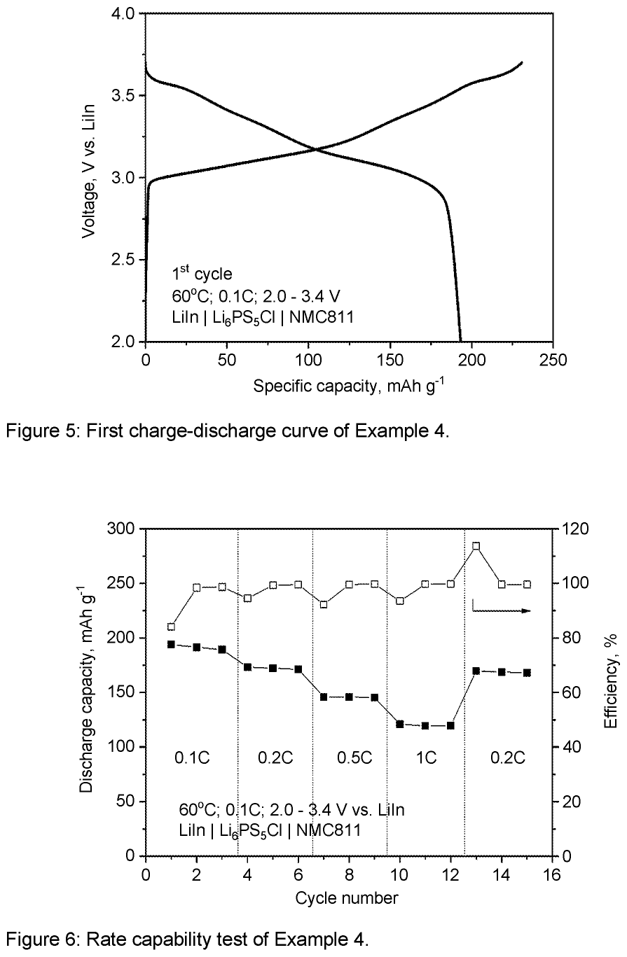

A test cell was prepared by pressing 100 mg of the solid sulfide electrolyte obtained in Example 1 at 2 tons in a Teflon 10-mm die to form a separator. A cathode disk consisting of NMC811, conductive carbon and the solid sulfide electrolyte obtained in Example 1 in mass ratio of 63:3:33 with 1 wt. % of PTFE and a LiIn alloy disks were added on the two sides of the separator. All cell components were compressed and the compressed cell was sealed with hermetic sleeves. The cell was cycled in a climate chamber at 60° C. FIG. 5 represents the first charge-discharge curve. FIG. 6 demonstrates the rate capability test.

1-15. (canceled)

16. A method for manufacturing a solid sulfide electrolyte comprising the following steps:
providing a solid electrolyte precursor mixture comprising Li₂S, Li₃PS₄ and LiX;
mixing of the solid electrolyte precursor mixture to obtain a solid electrolyte mixture; and
heat-treating of the solid electrolyte mixture to obtain a solid sulfide electrolyte having an argyrodite-type crystal structure;
wherein X is a halogen selected from F, Cl, Br, I or combinations thereof.

17. The method for manufacturing the solid sulfide electrolyte according to claim 16, wherein the solid sulfide electrolyte is represented by formula (I)
Li_{7-y}PS_{6-y}X_{y} (I)
wherein y is 0.8 to 1.7.

18. The method for manufacturing the solid sulfide electrolyte according to claim 16, wherein the solid sulfide electrolyte is represented by formula (II)
Li₆PS₅X (II).

19. The method for manufacturing the solid sulfide electrolyte according to claim 16, by mixing the solid electrolyte precursor at a mixing speed between 1 and 250 rpm.

20. The method for manufacturing the solid sulfide electrolyte according to claim 16, wherein the mixing of the solid electrolyte precursor mixture occurs at a mixing time between 1 hour and 72 hours.

21. The method for manufacturing the solid sulfide electrolyte according to claim 16, wherein the molar ratios of Li₂S:Li₃PS₄:LiX is 1:1:1.

22. The method for manufacturing the solid sulfide electrolyte according to claim 16, wherein X=Cl, Br, I or combinations thereof.

23. The method for manufacturing the solid sulfide electrolyte according to claim 16, wherein the heat-treating occurs at a temperature between 10° and 1000° C.

24. The method for manufacturing the solid sulfide electrolyte according to claim 16, wherein the heat-treating occurs between 0.5 hour and 24 hours.

25. The method for manufacturing the solid sulfide electrolyte according to claim 16, wherein the heat-treating occurs under an inert atmosphere or an atmosphere comprising a hydrogen sulfide gas.

26. The method for manufacturing the solid sulfide electrolyte according to claim 16, wherein the mixing is carried out by using a ball mill, a bead mill, a homogenizer, a horizontal mixer, a ploughshare mixer, a screw mixer, ajar mill, a drum mill or a roller bench.

27. The solid sulfide electrolyte obtainable by the method according to claim 16.

28. The solid sulfide electrolyte according to claim 27 having an ionic conductivity higher than 0.1 mS/cm, and/or an electronic conductivity less than 1×10⁻² mS/cm.

29. The solid sulfide electrolyte according to claim 27 having a purity of at least 90% as determined by XRD.

30. A battery comprising a negative electrode, a positive electrode and a solid electrolyte layer, wherein at least one of the positive electrode, the negative electrode, and the solid electrolyte layer comprises the solid sulfide electrolyte according to claim 27.
